(19) United States
(12) Patent Application Publication
(10) Pub. No.: US 2014/0366523 A1
(43) Pub. Date: Dec. 18, 2014

(54) ACTUATOR FOR GENERATING POSITIONING MOVEMENTS

(71) Applicant: FG-INNOVATION GMBH, Bochum (DE)

(72) Inventors: Sven Langbein, Menden (DE); Alexander Czechowicz, Bochum (DE)

(21) Appl. No.: 14/348,518

(22) PCT Filed: Sep. 28, 2011
(86) PCT No.: PCT/EP2011/066850

§ 371 Date: Jul. 10, 2014

(51) Int. Cl. F03G 7/06

(52) U.S. Cl. CPC F03G 7/065
USPC 60/527

(57) ABSTRACT

The invention relates to an actuator for generating positioning movements by means of shape memory elements, comprising a housing on which an actuation element that carries out positioning movements in conjunction with shape memory elements is arranged, and means for adjusting and altering the positioning movement of the actuator, wherein a modular actuator has an actuation element (2) that is arranged on a housing (1) and carries out longitudinally guided positioning movements. The actuation element (2) is coupled to two shape memory elements (7, 8) in such a manner that when a transition temperature is exceeded the first shape memory element (7) generates a translatory or rotational positioning movement of the actuation element (2) and the second shape memory element (8) generates an adjustable return movement of the actuation element (2).

The invention relates to an actuator for generating positioning movements by means of shape memory elements in accordance with the preamble of Claim 1.

Shape memory elements are known from the prior art. They are used to generate positioning elements initiated by heating and a crystalline transformation associated therewith. In the process, shape memory elements can be reminiscent of a shape previously impressed through annealing. This effect is referred to as a thermal effect. A resetting element that deforms the shape memory element again in the cold state must be provided so that a repeatability of the positioning movement can be guaranteed. Conventional resetting spring elements however have the disadvantage that they reduce the performance of the shape memory element to a considerable extent due to their increasing spring characteristics. If the shape memory element is heated again subsequently, it reverts to its initial shape. The heating takes place in the process by a surrounding medium or by the electrical equivalent serial resistance of the shape memory element. While the heating by means of a surrounding medium regulates the system internally, it does not permit an external regulation of the positioning movement. The heating by the electrical equivalent serial resistance is only suitable for smaller cross-sections due to the often limited current or voltage; however it does have the advantage of an external controllability.

A linear movement actuator is known from U.S. Pat. No. 4,806,815 that contains a shape memory element in the form of a wire that contracts in the event of exceeding the transition temperature and in the process pushes an actuator in the form of a rod upward. In the case of the cooling of the shape memory element, a steel spring contracts the rod back to the initial position. The actuator carries out only general translation movements to this end. In DE 198 02 639 A1 a movement device with shape memory drive is described in which a shape memory element is arranged on an actuation element guided through a sleeve such that a contraction or elongation of the shape memory element due to a change in temperature triggers a positioning movement of the actuation element. The resetting to the initial state takes place in turn by a steel spring.

Proceeding from the prior art, the object of the invention is to create an actuator for generating positioning movements by means of shape memory elements by means of having the resetting likewise assumed by a shape memory element so that one obtains as a result a very compact and simple construction of an actuator and in addition the performance of the actuator is increased.

Another problem of the invention consists in increasing the flexibility and range of potential applications through a modular structure, e.g. by the integration or connection of mechanical converters.

For the solution of this problem the invention proposes a modular design actuator with an actuation element arranged on a housing carrying out longitudinally guided positioning movements that is coupled to two shape memory elements such that the first shape memory element generates a translatory or rotational positioning movement of the actuation element when a transition temperature is exceeded and the second shape memory element generates an adjustable return movement of the actuation element.

Due to the fact that contrary to the prior art, in the case of this design of the actuator by coupling the actuation element to two shape memory elements by means of the second shape memory element, a return movement of the actuation element is generated with an optimized or adjustable positioning movement, the actuator is compact in build and powerful. A significant advantage also consists in the fact that through the modular design of the actuator both translatory and also rotational positioning movements of the actuation element can be generated with different travel distances and actuating forces or actuation angles and torques as well as also a versatility is guaranteed.

One advantageous embodiment involves two shape memory elements being able to be arranged differently to one another and held on the longitudinally guided actuation element in the housing, wherein the two shape memory elements are each fastened with their two free ends to the opposing ends of the housing. The fastening of the two shape memory elements is provided positively, non-positively or firmly both on the actuation element as well as also on the housing. For example the shape memory elements can be fastened by means of screws on the housing or be cast directly or injected into the plastic housing.

In one basic structure the two shape memory elements are each held centrally at the actuation element, longitudinally guided in the housing and are each fastened with their two free ends to the opposing ends of the housing, wherein the first shape memory element is designed V-shaped in an initial position and the present angle changes when a transition temperature is exceeded and as a result the actuation element carries out a positioning movement. The second shape memory element has a shape designed essentially in a straight line in this initial position, however, after activation of the first shape memory element it takes on a V-shaped end position.

As an alternative, provision is preferably made as a variation that the two shape memory elements are connected to the pivot points of a 4-bar mechanism and as a result in crossed arrangement or the two shape memory elements are arranged at right angles to one another. Due to these arrangements travel distances and actuating forces are subject to change.

Preferably provision is made that the second shape memory element has either the thermal shape memory effect or the pseudo-elastic shape memory effect depending on the application.

The second shape memory element is provided being able to be actuated and generates a return movement of the actuation element by means of its thermal shape memory effect, independently from the cooling of the first shape memory element through a heating, wherein stepped return characteristics can be generated. If the second shape memory element has the pseudo-elastic shape memory effect, the elasticity of the shape memory element is subject to change so that the second shape memory element generates different reset forces.

One preferred embodiment of the actuator involves the size of the translatory or rotational positioning movement or the size of the actuating force or of the actuating torque of the actuation element being able to be changed by different arrangements of the shape memory elements to one another, wherein the size of the translatory or rotational positioning movement or the size of the actuating force or of the actuation element can be changed by means of a transmission gear, preferably by a lever mechanism, or provision is made that by means of a conversion gear a translatory movement can be converted to a rotational movement.

One advantageous development involves the actuator being designed as a modular system, which consists of different base modules as well as sensor, conversion, locking, braking and heating modules, whose modules are designed as a production series, wherein the modules of the actuator have standardized mechanical, electrical and information technology interfaces. As a result, through a modular and standardized structure the actuator can be produced efficiently and can be used in a wide variety of applications by variation possibilities.

The invention will be explained in greater detail with the help of exemplary embodiments schematically represented in drawings. The figures show the following:

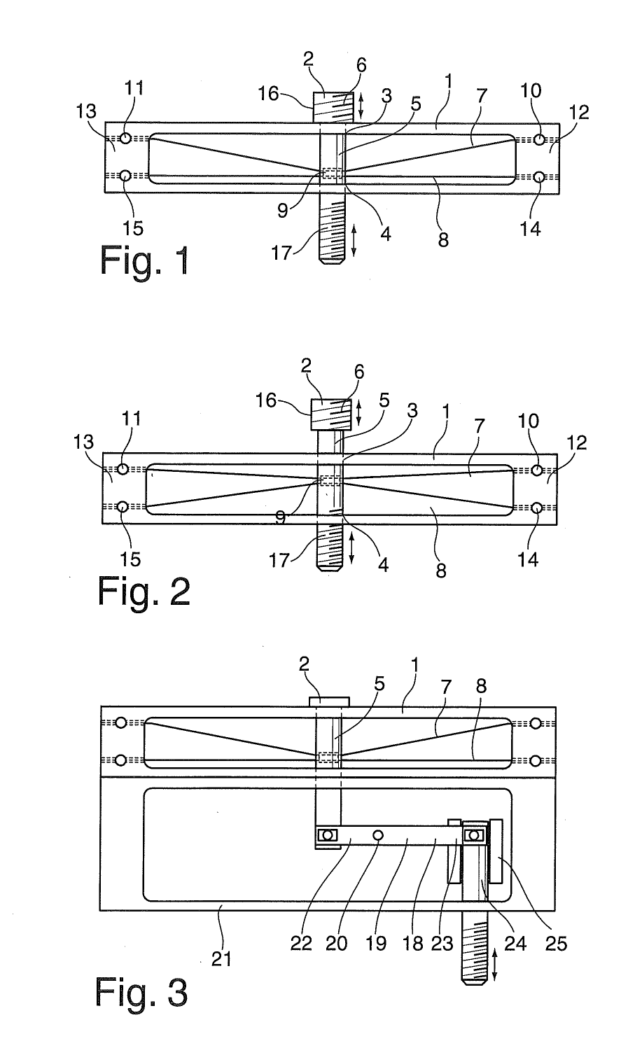

FIG. 1 shows a first exemplary embodiment of an actuator in initial position,

FIG. 2 shows the actuator in switch position,

FIG. 3 shows a second exemplary embodiment of an actuator with a lever mechanism module,

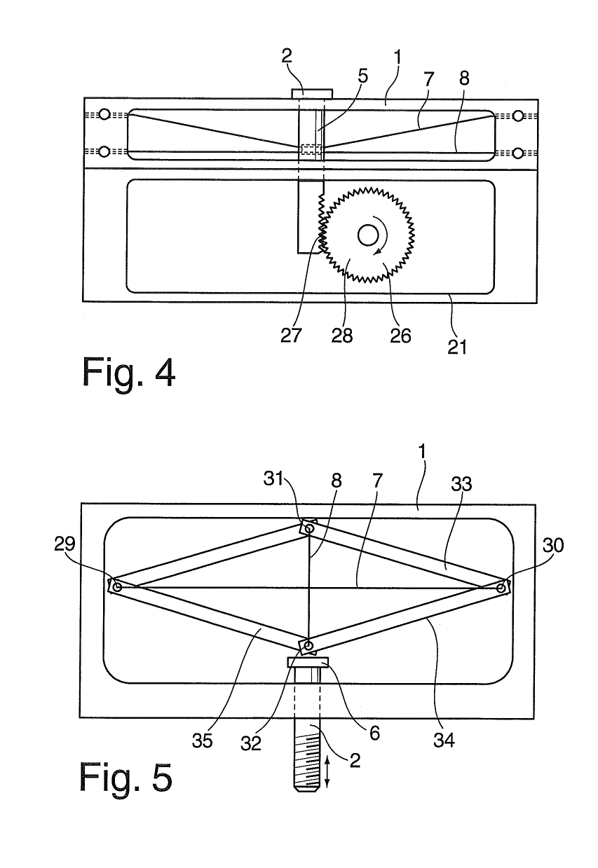

FIG. 4 shows a further exemplary embodiment of an actuator with a conversion gear module,

FIG. 5 shows a further exemplary embodiment of an actuator with integrated 4-bar mechanism,

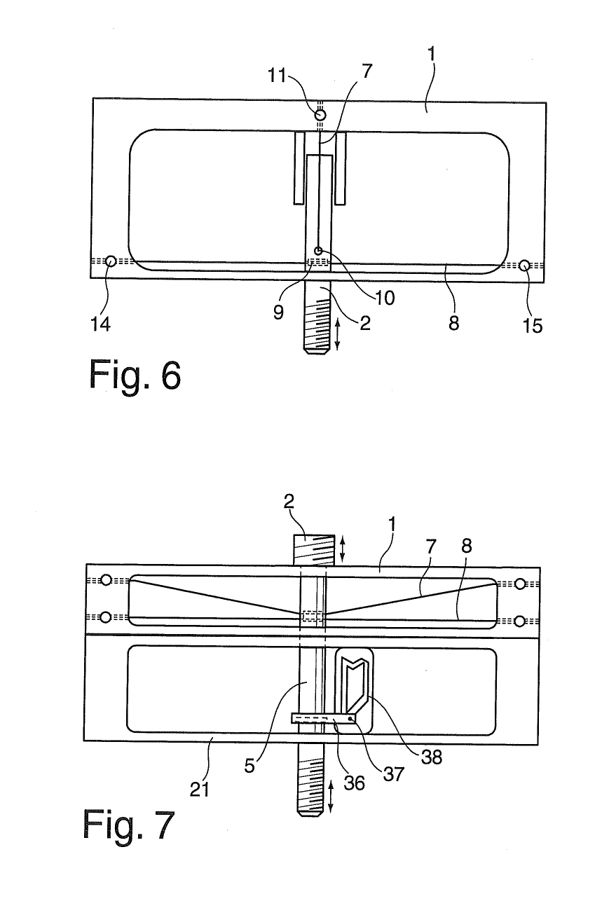

FIG. 6 shows a further exemplary embodiment of an actuator with shape memory elements arranged perpendicular to one another and

FIG. 7 shows a further exemplary embodiment of an actuator with locking mechanism.

FIG. 1 shows an inventive actuator with a basic structure in an initial position. In a housing 1 an actuation element 2 is longitudinally guided in boreholes 3, 4 in the housing 1 such that the actuation element 2 carries out a translation movement in both directions upward and downward. The actuation element 2 consists of a preferably rod-shaped base body 5 passing through the housing 1 in longitudinal direction which is held on the housing 1 with a head part 6. The actuation element 2 is coupled with two shape memory elements 7, 8 to the rod-shaped base body 5 in a coupling position 9, wherein the first shape memory element 7 is pushed through a transverse bore 9 arranged in the rod-shaped base body 5 of the actuation element 2 and with its two free ends 10, 11 is firmly connected at the opposing housing ends 12, 13 to the housing 1. In the process the first shape memory element 7 has, in this initial position, an essentially V-shaped form. When the transition temperature is exceeded the first shape memory element 7 contracts in accordance with FIG. 2, and the actuation element 2 is as a result pressed upward and carries out a translatory positioning movement. The second shape memory element 8 is likewise pushed through the transverse bore 9 arranged in the rod-shaped base body 5 of the actuation element 2 and firmly is connected with its two free ends 14, 15 to the housing 1 and is likewise as a result deformed. To this end the second shape memory element 8 has, in the initial position, an essentially straight-line shape. If the second shape memory element 8 has the thermal shape memory effect, it assumes its old form again when heated and thus generates a return movement of the actuation element 2. On the other hand, if the second shape memory element 8 has the pseudo-elastic shape memory effect, in the event of the cooling of the first shape memory element 7 it will reset the actuation element 2 due to its elastic properties. If the second shape memory element 8 has the pseudo-elastic shape memory effect, it can be actively actuated and thus change its elasticity. The two shape memory elements 7, 8 are preferably designed as wires, rods or metal sheets. The housing 1 as well as the actuation element 2 can have different shapes depending on the application. For flexible coupling of the actuator to other systems, threads 16, 17 are arranged on the head part 6 and on the base body 5 of the actuation element 2.

In a second exemplary embodiment according to FIG. 3 the size of the translatory positioning movement of the actuation element 2 is changed by means of a transmission gear module which is fasted on the standard actuator. The transmission gear is, in the process, designed as a lever mechanism 18. A lever 19 of the lever mechanism 18 is mounted on a mounting point 20 in a housing module 21 coupled on the housing 1 and has the two lever arms 22, 23. The lever arm 22 is connected in an articulated manner to the end of the rod-shaped base body 5 of the actuation element 2 and the lever arm 23 is connected in an articulated manner to an actuation bolt 24 which is longitudinally guided by means of a guide 25 in the housing module 21 so that the translation movement of the actuation element 2 is translated to a greater translation movement of the actuation element 2 due to the leverage ratio.

FIG. 4 shows a further exemplary embodiment of an actuator in which the translation movement of the actuation element 2 is converted by a conversion gear module 26 to a rotational movement. The conversion in this exemplary embodiment takes place by a rack and pinion drive mechanism. The end of the rod-shaped base body 5 of the actuation element 2 is to this end designed as a gear rack 27. A gear 28 engages in the gear rack 27, said gear 28 being mounted in the housing module 21. If the actuation element 2 carries out a translatory positioning movement, it is converted to a rotational positioning movement and forwarded.

In the exemplary embodiment shown in FIG. 5 the two shape memory elements 7, 8 are connected to pivot points 29, 30, 31, 32 of a 4-bar mechanism 33 and as a result in crossed arrangement. The pivot points of the 4-bar mechanism can. in the process, also be designed as solid body joint. The 4-bar mechanism 33 is arranged in the housing 1 such that it presses with its lower legs 34, 35 on the head part of the actuation element 2 and when the first shape memory element 7 is heated, the actuation element 2 carries out a translatory positioning movement. The present arrangement is characterized in that the travel distance of the shape memory element is enlarged.

FIG. 6 shows an exemplary embodiment in which the two shape memory elements 7, 8 are arranged at right angles to one another. The first shape memory element 7 is. in the process. arranged along the actuation element 2 such that it is fastened with one end 10 on the actuation element 2 and with the other end 11 on the housing 1. If the first shape memory element 7 contracts due to the thermal effect, the actuation element 2 is pulled upward and carries out a translatory positioning movement. The present arrangement is characterized in that great actuating forces can be achieved through the tensile load of the shape memory element.

In a further exemplary embodiment according to FIG. 7 an actuator with an integrated locking mechanism is shown which has the task of holding the end position of the actuator without electrical power so that the actuator has a bistable operation. To this end a locking element 36 is arranged on the rod-shaped base body 5 of the actuation element 2, said locking element engaging with a pin 37 into a curve-shaped groove 38 arranged in the housing module 21 which is shaped such that the pin 37, in the event of the translatory positioning element of the actuation element, locks in place in the upper position and thus holds the actuation element 2 in this position until the locking element 36 is disengaged.

For effective realization of the actuator, it is expedient to design the actuator as a modular system consisting of different base modules as well as sensor, conversion, locking, braking and heating modules, whose modules are designed as production series, wherein the modules of the actuator have standardized mechanical, electrical and information technology interfaces.

The invention is not restricted to the exemplary embodiments, but rather is variable in the arrangement, design and type of shape memory element and connection modules employed. It comprises in particular also variants that can be formed by combination of the features or elements described in connection with the present invention. All features mentioned in the foregoing description as well as features that can be inferred from the drawings are further components of the invention, even if they are not given particular emphasis and mentioned in the claims.

1. Actuator for generating positioning movements by means of shape memory elements, comprising a housing, at which an actuation element is arranged, which in coupling with shape memory elements carries out positioning movements and means for setting and changing the positioning movement of the actuator, characterized in that a modular design actuator has an actuation element (2) arranged on a housing (1) executing longitudinally guided positioning movements that is coupled to two shape memory elements (7, 8) such that the first shape memory element (7) generates a translatory or rotational positioning movement of the actuation element (2) when a transition temperature is exceeded and the second shape element (8) generates an adjustable resetting movement of the actuation element (2).

2. Actuator according to claim 1, wherein the two shape memory elements (7, 8) are able to be arranged differently to one another and held on the longitudinally guided actuation element (2) in the housing (1), wherein the two shape memory elements (7, 8) are each fastened with their two free ends (10, 11) and (14, 15) to the opposing ends (12, 13) of the housing (1) and wherein the fastening of the two shape memory elements (7, 8) is provided positively, non-positively or cohesively both on the actuation element (2) as well as also on the housing (1).

3. Actuator according to claim 1, wherein the two shape memory elements (7,8) are fastened by means of screw connections or crimp sleeves on the housing (1) or cast directly or injected in the housing (1).

4. Actuator according to claim 1, wherein the second shape memory element (8) is provided being able to be actuated and generates a return movement of the actuation element (2) by means of its thermal shape memory effect, independently from the cooling of the first shape memory element (7) through a heating, wherein stepped return characteristics are generatable.

5. Actuator according to claim 1, wherein the second shape memory element (8), by means of its pseudo-elastic shape memory effect, performs a reset of the actuation element (2) in the event of the cooling of the first shape memory element (7), wherein the second shape memory element (8) is provided able to be actuated and changes its elasticity such that different reset forces are generatable.

6. Actuator according to claim 1, wherein the size of the translatory or rotational positioning movement or the size of the actuating force or of the actuating torque of the actuation element (2) are changeable by different arrangements of the shape memory elements (7, 8) to one another.

7. Actuator according to claim 1, wherein the size of the translatory or rotational positioning movements or the size of the actuating force or of the actuation element (2) is changeable by means of a transmission gear, preferably by a lever mechanism.

8. Actuator according to claim 1, wherein a translation movement is converted to a rotational movement by means of a conversion gear.

9. Actuator according to claim 1, wherein an integrated locking mechanism or a locking module is provided that holds the end position of the actuation element (2) without electrical power.

10. Actuator according to claim 1, wherein the actuator designed as a modular system consists of different base modules as well as sensor, conversion, locking, braking and heating modules, wherein the modules are designed as a production series.

11. Actuator according to claim 1, wherein the modules of the actuator have standardized mechanical, electrical and information technology interfaces.

12. Actuator according to claim 7, wherein the transmission gear is a lever mechanism.
